(19) United States
(12) Patent Application Publication
(10) Pub. No.: US 2019/0145602 A1
(43) Pub. Date: May 16, 2019

(54) LIGHT DEVICE FOR A VEHICLE

(71) Applicant: Varroc Lighting Systems, s.r.o., Senov u Noveho Jicina (CZ)

(72) Inventors: Jan Martoch, Hranice (CZ); Pavel Vlcek, Olomouc - Neredin (CZ)

(21) Appl. No.: 16/181,546

(22) Filed: Nov. 6, 2018

(30) Foreign Application Priority Data
Nov. 14, 2017 (CZ) PV 2017-734

(51) Int. Cl. F21S 43/31; F21S 41/141; F21S 43/14; F21S 43/20; F21S 41/32; F21S 45/40; F21S 43/27

(52) U.S. Cl. CPC F21S 43/31; F21S 41/141; F21S 43/14; F21Y 2115/10; F21S 41/32; F21S 45/40; F21S 43/27; F21S 43/26

(57) ABSTRACT

The light device for a vehicle comprises an optical module comprising a reflector (2), common for signal light functions, e.g. the daily running light or position light, and for the low beam/high beam lighting, a main light source (4) designed for the said low beam/high beam lighting, and a secondary light source (3) designed for the signal light functions. Between the secondary light source (3) and the reflector (2), a micro-lens (1) is situated, configured to increase the diffusion of light emitted by the secondary light source (3) before it falls onto the reflector (2).

### RELATED APPLICATIONS

This application claims the priority of Cvzech Patent Application Ser. No. PV 2017-734 filed on Nov. 14, 2017, the entire disclosure of which is herein incorporated by reference.

### FIELD OF THE INVENTION

The invention relates to a light device for a vehicle that comprises a common reflector for signal lighting which is, e.g., daytime running lighting and low-beam/bight beam lighting.

### BACKGROUND INFORMATION

High-beam or low-beam lighting is one of the main functions of front headlights of vehicles, which are generally intended to illuminate the carriageway. Secondary functions comprise daytime running lighting or directional lights fulfilling the function of a signaling device intended to send a light signal to other users of the road. To reduce production costs of lights, combined vehicle lighting providing different signaling and lighting functions within one light device is being continuously improved in the automotive industry.

An invention that combines a LED fog light and a LED for daytime running lighting in vehicles is described in US2015117046. The lamp comprises multiple reflectors, the first group of light-emitting diodes (LED) comprising the first LED situated at the focal point of the first reflector and the second group of LED's comprising the second LED situated outside the focal point of the first reflector. The method of switching between the fog light and the daytime running light comprises power supply of the LED's of the first group situated at the focal point of the reflectors to produce the first type of light emission, or power supply of the LED's of the second group situated outside the focal point of the reflectors to produce the second type of light emission, and power supply of one LED situated at the focal point of the reflector.

A light device of a motor vehicle that has at least two light sources wherein the first light source is designed for the high-beam and low-beam lighting and the other light source is designed for the daytime or signaling lighting is described in the German patent DE 102010056312 B4. The light device further comprises a reflector to combine light beams from two sources and to generate two different light beams. This effect is achieved by the reflector having a specific reflective surface consisting of two different textures, the first texture being adapted to the first source and the other texture to the second source of light. To achieve the best effect, the textures are arranged on the specific reflective surface in a chessboard pattern. A disadvantage of this solution is that the light source, in this case a LED, is situated outside the focal point of the reflector, which results in the light ray from the other light source for signaling lighting not having a sufficient width and conversely having too high light intensity to meet the legislative specifications for the daytime running lighting and parking lighting.

Controlling the light characteristic of a light source by means of an optical assembly comprising a lens with a supplementary optical element is commonly known, e.g. from the patent U.S. Pat. No. 7,837,360. The patent discloses an optical module comprising a point light source and a lens that are separated from each other with an air layer in such a way that the optical lens surrounds the point light source and asymmetrically refracts light emitted from the light source. The principle of the solution is that the optical lens is in contact with an air layer, comprises an inner surface and outer surface and transfers light from the light source through the inner surface onto the outer surface, the inner surface having a different cross-section and the shape of a semi-circular curve, which asymmetrically changes the characteristic of light emitted from the outer side of the lens.

The object of the invention is to propose a light device of a vehicle that will eliminate or minimize some disadvantages of the prior art and comprises a reflector common for signal functions as, e.g., the daytime running light or position light, and for low beam/high beam lighting.

### PRINCIPLE SUMMARY OF THE INVENTION

The above-mentioned object is achieved by a light device for a vehicle according to the invention, comprising an optical module including a reflector, common for signal light functions, e.g., the daily running light or position light, and for the low beam/high beam lighting, a main light source designed for the said low beam/high beam lighting, and a secondary light source designed for the said signal light functions. Between the secondary light source and the reflector, a micro-lens is situated, configured to increase the diffusion of light emitted by the secondary light source before it falls onto the reflector.

The main light source can be situated at the focal point of the reflector.

The secondary light source can be situated at the focal point of the micro-lens.

The reflector advantageously has a parabolic shape.

The secondary light source and the main light source can be situated on a common PCB that a cooler is connected to.

In one of the embodiments, the micro-lens is, on its surface, fitted with a structure configured to increase the diffusion of light emitted by the secondary light source. This structure can be surface roughening.

In one of the embodiments, the surface of the micro-lens averted from the secondary light source is spherical.

The surface of the micro-lens facing the secondary light source can comprise a groove created in a horizontal direction and configured to increase, in a vertical plane running through the secondary light source and being perpendicular to the groove, diffusion of the light emitted by the secondary light source. A transversal profile of the groove can be a segment of a circle.

In one of the embodiments, the groove is created in a vertical plane perpendicular to a longitudinal axis of vehicle.

In one of the embodiments, the micro-lens is configured so that a diffuse of light in a vertical plane being perpendicular to the vehicle longitudinal axis and running through the secondary light source differs from a diffuse of light in a vertical plane being parallel to the vehicle longitudinal axis and running through the secondary light source.

In one of the embodiments, the micro-lens is attached by means of fixing pins to the PCB and situated against the secondary light source.

The micro-lens can be seated in a holder carried by the fixing pins.

The secondary light source and the main light source can be LED sources.

The solution according to the invention has the following advantages among other things:
the optical module for a vehicle light can be used in small compact headlights where there is no longer enough space to install a separate daytime running light (DRL) unit, which has the defined minimum size of 25 cm² for the ECE markets and 40 cm² for the CCC markets,
the solution is cost-effective because it does not require an extra optical system and the reflector used for the high-beam and low-beam lighting is used for the signal lighting,
there is a common PCB for the primary and secondary source of light,
the micro-lens ensures sufficient diffusion of light so as not to exceed the maximum allowed intensity in the output light image.

### CLARIFICATION OF DRAWINGS

The present invention will be clarified in more detail with reference to drawings where:

FIG. 1 shows a perspective view of the optical module of a light device according to the invention,

FIG. 2 shows a front view of the optical module of FIG. 1,

FIG. 3 shows a side view of the optical module of FIG. 1,

FIG. 4 shows a perspective view from the bottom of an embodiment example of the micro-lens seated in a holder,

FIG. 5 shows a view from the bottom of the micro-lens in the holder of FIG. 4,

FIG. 6 shows a perspective top view of the micro-lens in the holder of FIG. 4,

FIG. 7 shows coordinates X and Y of the vehicle, and

FIG. 8 shows examples of possible orientation of the groove that the surface of the micro-lens facing the secondary light source is fitted with in a preferred embodiment.

### EXAMPLES OF THE INVENTION EMBODIMENTS

For the purposes of this invention, the “micro-lens” does not refer to a lens in a conventional sense, but it refers to a diffusing optical micro-element. This diffusing optical micro-element is called the “micro-lens” 1 for the purposes of the present invention. The micro-lens 1 is configured for the diffusion of light that is produced by the secondary light source 3 and falls onto the micro-lens 1.

The main light source 4 and the secondary light source 3 are preferably LED sources. A multi-chip LED diode is also considered as a single LED source.

The light device according to the invention comprises an optical module that comprises one reflector 2 that is common for the main light source 4 and secondary light source 3. The secondary light source 3 is designed for the signaling function and a micro-lens 1 is associated with it, ensuring diffusion of light produced by the secondary light source 3 and falling onto the micro-lens 1. Besides the said optical module, the light device according to the invention can (but need not) comprise other/different optical modules, which, however, are not covered by this invention.
Below, embodiments of this invention will be described.

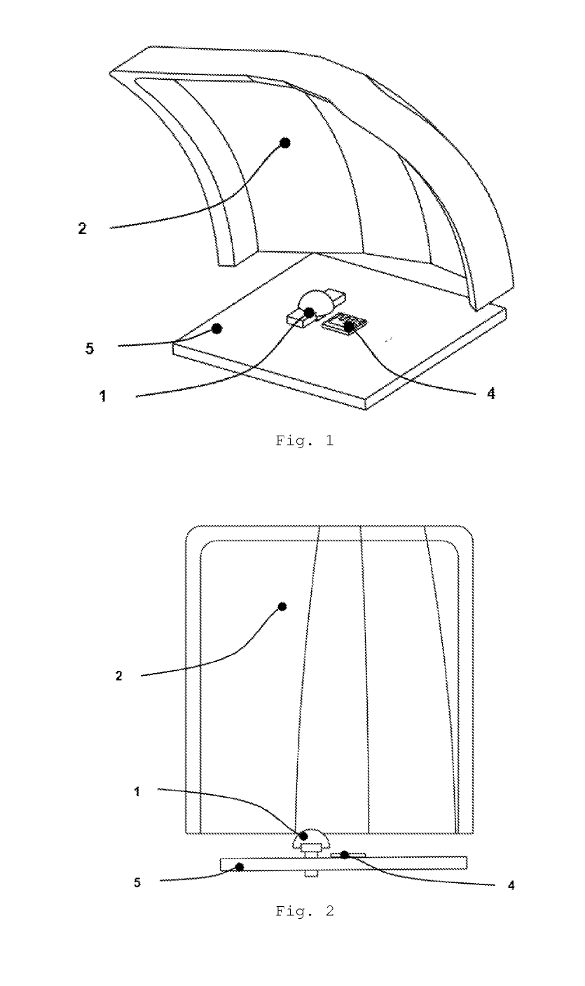

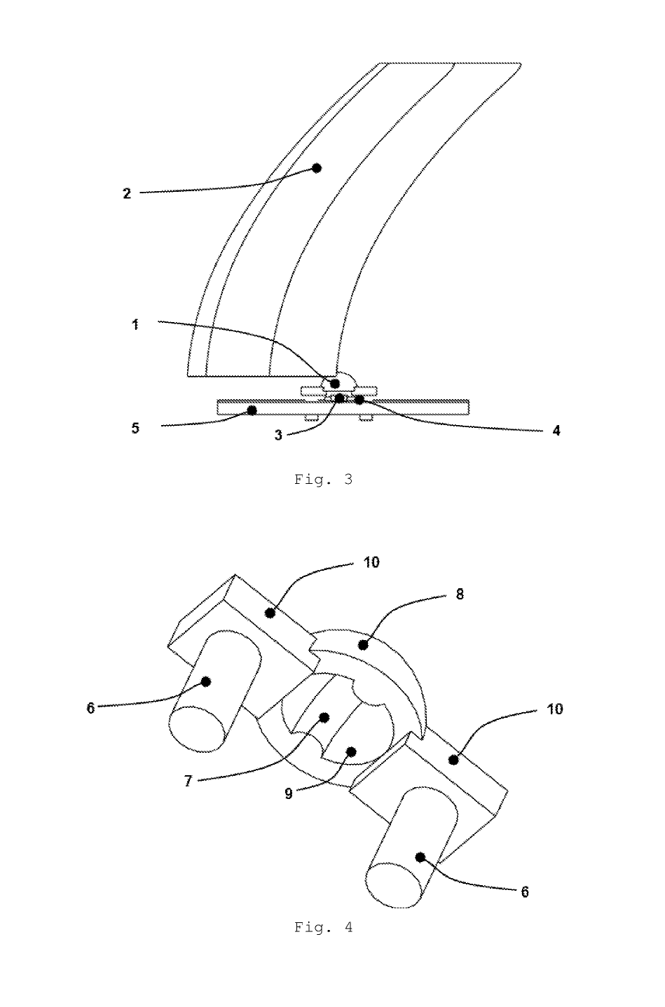

An embodiment example of the light device is shown in FIGS. 1 to 3. In this embodiment, the optical module comprises a single PCB 5 on which the main light source 4 is situated, a micro-lens 1 seated in a holder 10 being arranged next to it. The micro-lens 1 provides for the dispersion function. Its surface 8 averted from the secondary light source 3 can have a spherical shape. The secondary light source 3 is situated at the focal point of the micro-lens 1. The surface 9 of the micro-lens 1 facing the secondary light source 3 can be fitted with a groove 7.

The main light source 4 is especially designed for the high-beam lighting and for the low-beam lighting and the secondary light source 3 is designed for the signal lighting, especially the daytime running light or the outline light. The optical module further comprises a reflector 2, preferably of a parabolic shape that is common for the main light source 4 and the secondary light source 3. The PCB 5 can be provided with openings for mounting of fixing pins 6. The fixing pins 6 can be made of plastic. The holder 10 is fitted with fixing pins 6 designed to be attached to the PCB 5 through the openings in this PCB 5. The holder 10 and the micro-lens 1 can be made integrally as one piece.

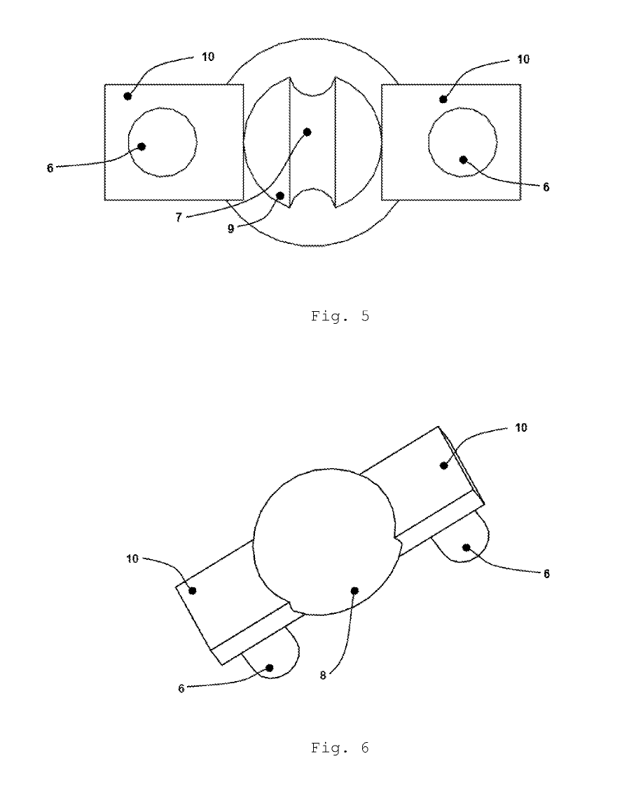

FIGS. 4 to 6 show an example of a particular embodiment of the micro-lens 1 seated in the holder 10 designed for attachment to the PCB 5. The micro-lens 1 has a surface 8 averted from the secondary light source 3 and a surface 9 facing the secondary light source 3, which has a spherical shape in this embodiment, and the surface 9 facing the light source is fitted with a groove adapted for diffusion of light in this embodiment. Other embodiments of the micro-lens 1 may have a different shape of the surfaces 8 and 9 and they do not need to have a groove 7 either, or they may have a differently designed groove.

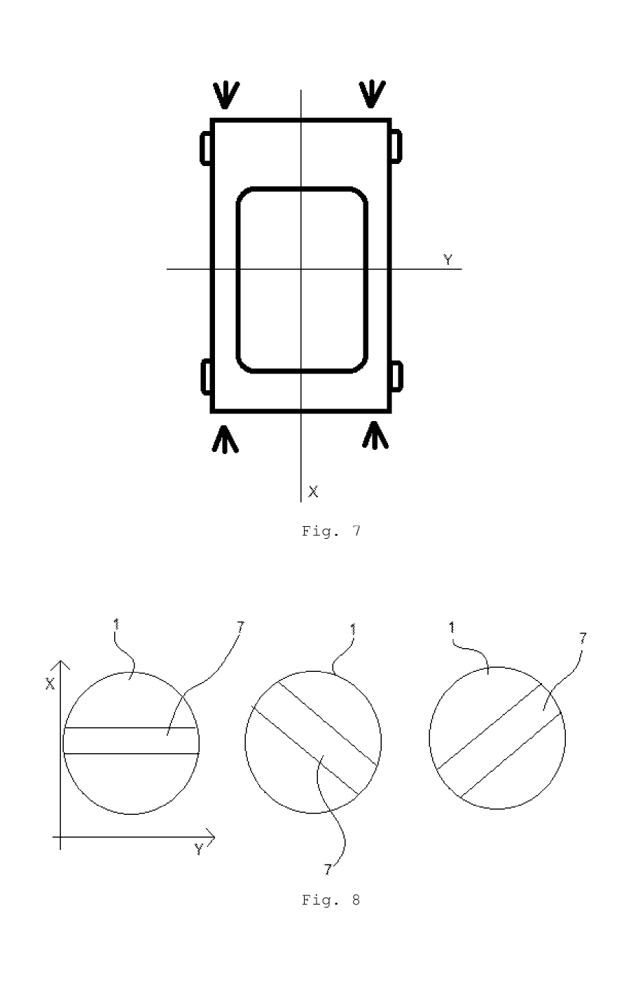

The groove 7 may have any suitable profile and any suitable orientation on condition it fulfils the required function, i.e. it contributes with its design to diffusion of light produced by the secondary light source 3. The groove 7 can thus be used to achieve controlled diffusion of micro-lens 1. The profile 7 of the groove can, e.g., have the form of a segment of a circle and it can be oriented in a horizontal direction transversally to the direction of the longitudinal axis of the vehicle to create additional light diffusion in the vertical direction. Examples of possible orientations of the groove 7 are shown in FIG. 8 in association with FIG. 7.

The micro-lens 1 in the optical module converts the Lambertian characteristic of the LED to a characteristic with large scattering of light. Advantageously, the new characteristic is not symmetrical and is different on the horizontal and vertical plane. To eliminate high intensity of light for the signal function, the surface 8 and/or 9 of the micro-lens 1 can be fitted with a structure configured to increase the diffusion of the light emitted by the secondary light source 3. This structure can, e.g., be surface roughening.

The invention also comprises a light device design that comprises more optical modules the structures of which can differ from each other. The invention also comprises a design wherein the module that comprises the reflector 2 comprises more main light sources 4 and/or secondary light sources 3.

The invention is not only limited to the embodiments described above, but it covers all modifications and adaptations that fall within the scope of the patent claims below.

### LIST OF REFERENCE MARKS

1—micro-lens

2—reflector

3—secondary light source

4—main light source

5—PCB

6—fixing pin

7—groove

8, 9—surface (of the micro-lens)

10—holder

1. A light device for a vehicle, comprising an optical module including a reflector common for signal lighting and for the low beam/high beam lighting, a main light source designed for the low beam/high beam lighting, and a secondary light source designed for the signal lighting, wherein between the secondary light source and the reflector, a micro-lens is situated, the micro-lens being configured to increase diffusion of a light emitted by the secondary light source before the light falls onto the reflector.

2. The light device according to claim 1, wherein the main light source is situated at a focal point of the reflector.

3. The light device according to claim 1, wherein the secondary light source is situated at a focal point of the micro-lens.

4. The light device according to claim 1, wherein the reflector has a parabolic shape.

5. The light device according to claim 1, wherein the secondary light source and the main light source are positioned on a common PCB that a cooler is connected to.

6. The light device according to claim 1, wherein the micro-lens is, on its surface, fitted with a structure configured to increase diffusion of light emitted by the secondary light source.

7. The light device according to claim 6, wherein the said structure is a surface roughening.

8. The light device according to claim 1, wherein a surface of the micro-lens averted from the secondary light source is spherical.

9. The light device according to claim 1, wherein a surface of the micro-lens facing the secondary light source comprises a groove created in a horizontal direction and configured to increase, in a vertical plane running through the secondary light source and being perpendicular to the groove, diffusion of the light emitted by the secondary light source.

10. The light device according to claim 9, wherein a transversal profile of the groove is a segment of a circle.

11. The light device according to claim 9, wherein the groove is created in a vertical plane perpendicular to a longitudinal axis of the vehicle.

12. The light device according to claim 1, wherein the micro-lens is configured so that a diffuse of light in a vertical plane being perpendicular to a longitudinal axis of the vehicle and running through the secondary light source differs from a diffuse of light in a vertical plane being parallel to the vehicle longitudinal axis and running through the secondary light source.

13. The light device according to claim 1, wherein the micro-lens is attached by means of fixing pins to a PCB and positioned against the secondary light source.

14. The light device according to claim 13, wherein the micro-lens is seated in a holder carried by the fixing pins.

15. The light device in accordance with claim 1, wherein the secondary light source and the main light source are LED sources.
